(19) United States
(12) Patent Application Publication
(10) Pub. No.: US 2008/0270197 A1
(43) Pub. Date: Oct. 30, 2008

(54) PROJECT STATUS CALCULATION ALGORITHM

(75) Inventors: Joseph R. Rafter, Berwyn, PA (US); Russell W. Taylor, Vienna, VA (US); Vito R. Vitale, Atlantic Highlands, NJ (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/739,229

(22) Filed: Apr. 24, 2007

(51) Int. Cl. G06Q 10/00

(52) U.S. Cl. 705/7

(57) ABSTRACT

Disclosed are a method and system for assessing the status of a project that remove subjectivity from the status reporting by implementing an algorithm to calculate red, yellow, green status of each of a multitude of keys and the overall project. The assessment uses a series of questions based on risk management, project management, system engineering, architecture, and testing disciplines to probe projects and solicit objective responses with scores and a conversion of the score into a red, yellow, green status. The advantage to this solution is that a consistent standard is provided, eliminating the accidental or purposeful exclusion of key details in status reporting that frequently result in a more optimistic status than what reality should reflect.

### BACKGROUND OF THE INVENTION

1. Field of the Invention

This invention generally relates to project measurement and governance, and more specifically, the invention relates to procedures to assess the effectiveness of project execution and the health of the project.

2. Background Art

Automated systems have been generally described in the past for planning, scheduling, task managing, or monitoring, and the like, for purposes of managing a project. Many of these systems concentrate on particular aspects of the development of a project, such as the associated financial or manufacturing aspects thereof, but do not fully integrate all the varied tasks of the process. In reality, the development and evolution within a business enterprise of a particular project can require numerous, even hundreds or thousands of, individual tasks and subtasks.

In addition, a particular project often involves numerous tasks, inputs, interactions, and/or reviews for approval requiring the involvement of a wide variety of personnel within a business such as from among marketing, manufacturing, engineering, management departments, and so forth. Also, the completion of many tasks and subtasks is contingent upon information being available for use that is generated in other separate tasks. The ability to share, and have information ready for sharing or consideration when needed, is critical to an efficient outcome. This represents a complex process. Consequently, there exists a need for automated systems that can efficiently manage projects within a business.

For example, the International Business Machines Corporation (IBM) Global Business services (GBS) has widely deployed a project measurement and governance program called the “7 Keys to Success”, which is used to assess the effectiveness of project execution and the health of the projects. This is accomplished by providing project managers with training and guidance in what each “key” in the 7 Keys represents, and then asking them to select a red, yellow, or green status for each key and overall for the project. The results are then used by GBS leaders and risk managers for overall portfolio management, to identify where help and focus is required.

The “7 Keys to Success” program has been widely deployed and has itself achieved significant success. Nonetheless, it is believed that this program can be improved. For instance, in this approach, the selection of the red, yellow or green status is highly subjective, so different project managers (PM) might give very different assessments of the same project. This program also does not force the PM to always consider all of the critical aspects when arriving at an assessment. In addition, the program does not account for what the PM may not know; for example, a PM working a certain type of engagement for the first time may not be aware that a certain element they have not previously implemented is critical to the success of this new type of project.

### SUMMARY OF THE INVENTION

An object of this invention is to provide an improved project measurement and governance program.

Another object of the invention is to implement an objective algorithm to determine the status of each of a group of key aspects of a project.

These and other objectives are attained with a method of and system for assessing the status of a project. The method comprises the steps of identifying a multitude of key aspects of the project; and identifying a series of core questions relating to the project. These core questions are identified by (i) identifying an initial group of questions based on analysis and investigation of multiple earlier projects, (ii) identifying a set of criteria to evaluate said initial group of questions, and (iii) refining said initial group of questions to a core group of questions by using said set of criteria.

For each of the key aspects of the project, an associated set of questions is selected from said core group of questions. Also, for each of the sets of questions, (i) at least one of the questions is identified as a special indicator of a troubled project, (ii) a first subset of the questions is identified as indicative questions that directly reflect bad behavior or poor performance on a project, wherein predetermined answers to said indicative questions contribute given scoring values to the associated key aspect, and (iii) a second subset of the questions is identified as predisposition questions that identify factors that can create a predisposition to the associated key aspect becoming troubled.

Each of the key aspects receives a score based upon the answers to the associated set of questions; and a red, yellow or green state is assigned to each of the key aspects based upon the scores of said each key aspect. As part of this scoring, the red state is assigned to any of the key aspects if a predetermined answer is given to any one or more of the special indicator questions of the set of questions associated with said any key aspect.

The preferred embodiment of the invention, referred to as Project Certification, is an improvement on the above-discussed “7 Keys to Success” program. The preferred embodiment of the present invention removes subjectivity from the 7 Keys status reporting by implementing an algorithm to calculate the red, yellow, green, status of each of the 7 keys and the overall project. The only solution to this problem today is a purely subjective assignment of the red, yellow, or green status. With this approach, there is no consistency across the globe. An additional solution is required such that all projects have a standard benchmark for the 7 keys status reporting that is common across the globe and therefore a consistent measure of projects and subjectivity/ambiguity is removed.

In the preferred implementation, for example, the invention provides a series of questions based on risk management, project management, system engineering, architecture, and testing disciplines to probe projects and solicit objective responses with scores and a conversion of the score into a red, yellow, green status. The advantage to this solution is that a consistent standard is provided eliminating the accidental or purposeful exclusion of significant details in the 7 Keys status reporting that frequently results in a more optimistic status than what reality should reflect.

Also, in the preferred embodiment, these assessments are given individually to projects and then all the assessments are aggregated together. So individual projects can look at their own results “locally”, but results can also be combined and examined across regions and business sectors “centrally”. This is a powerful benefit of the standardization of the details of the questions and answers; systemic problems in the way a business is run can be identified by automated analytic processes, where prior to this, these trends had to be manually uncovered and verified.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 illustrates a computer screen showing seven keys of a project execution;

FIGS. 2, 3 and 4 list questions that may be used to determine the statuses of three of the keys of the project execution; and

FIG. 5 shows a computer that may be used in the practice of this invention.

### DETAILED DESCRIPTION OF THE PREFERRED EMBODIMENTS

The preferred embodiment of the present invention, referred to as Project Certification, provides a procedure that removes subjectivity from project status reporting by implementing an algorithm to calculate the status of each of seven keys of project execution and the overall project. The keys are identified as being red, yellow or green to indicate the status of the key. In this preferred embodiment, a series of questions based on risk management, project management, system engineering, architecture, and testing disciplines to probe projects and solicit objective responses with scores and a conversion of the score into a red, yellow, green status. The advantage to this solution is that a consistent standard is provided eliminating the accidental or purposeful exclusion of key details in the 7 Keys status reporting that frequently result in a more optimistic status than what reality should reflect. The specific number of questions can vary over a wide range and can evolve over time. With one specific example of the invention, 76 questions were used to determine the status of the keys.

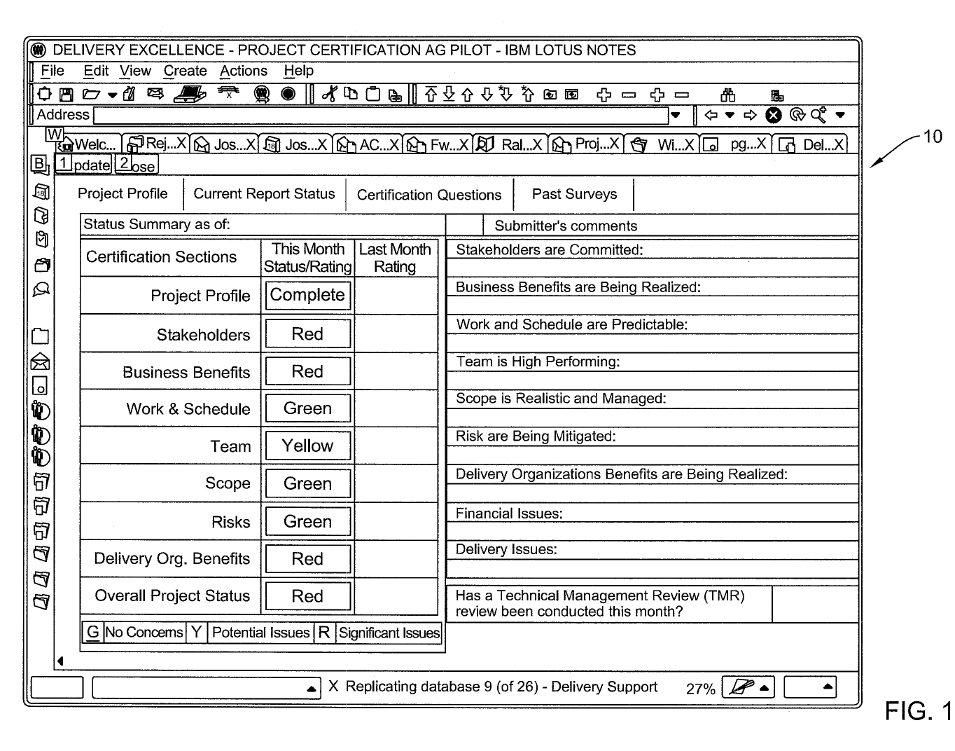

As one example, a Lotus Notes database may be provided that solicits general data (e.g. project name, sector, industry, etc.) and answers to the series of questions across the 7 keys. The certification is completed based on working through the screen sample shown at 10 in FIG. 1. It may be noted that the present invention may be deployed into multiple technical environments; and, as another example, the invention may be embodied in a Web implementation using Lotus Domino. Also, different types of projects may answer different subsets of questions.

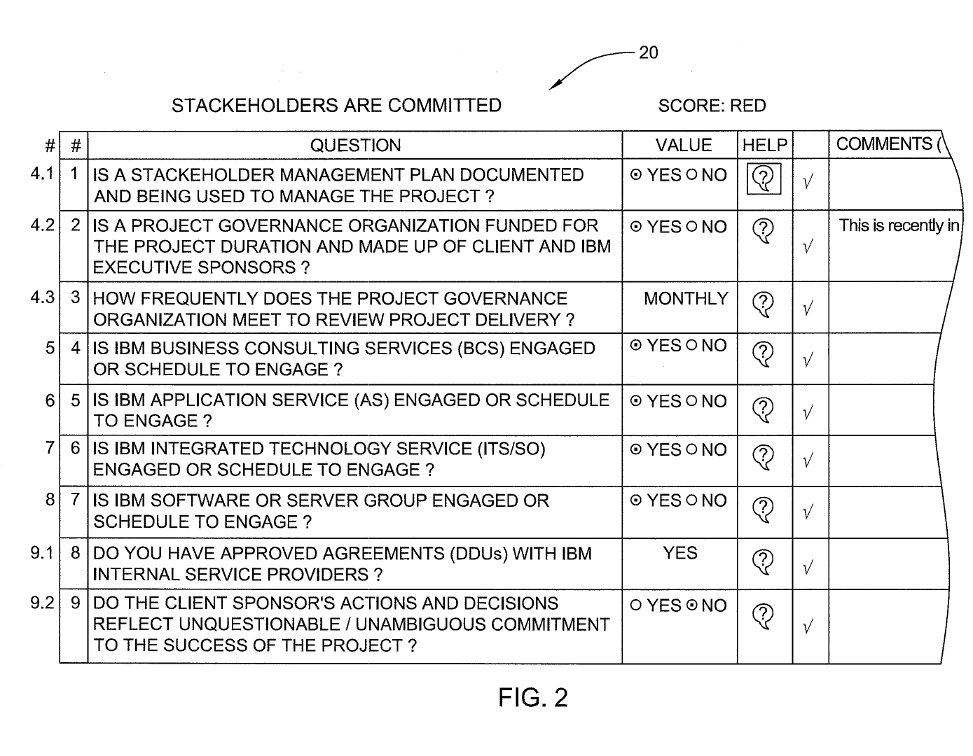

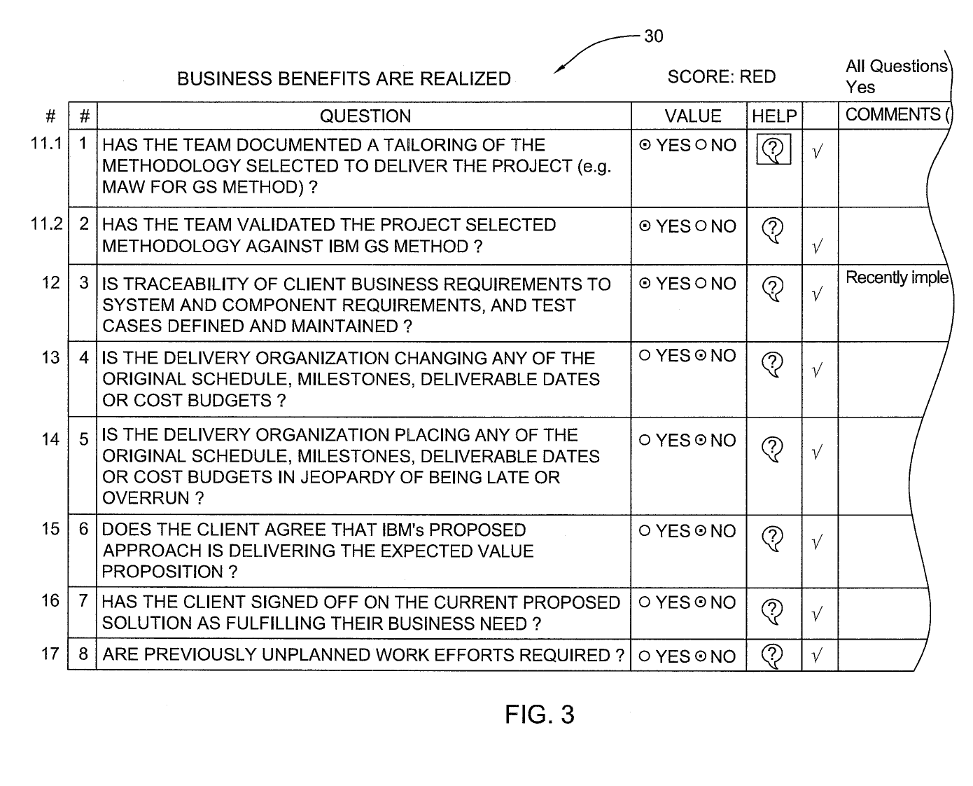

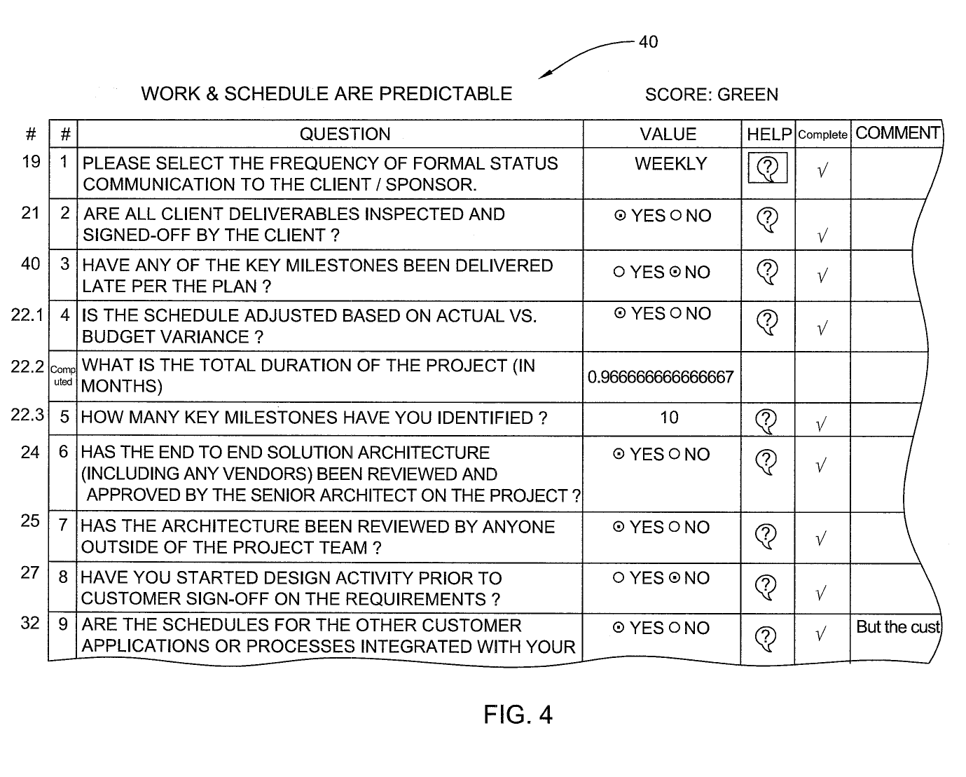

FIGS. 2-4 show actual questions that may be used to determine the statuses of “Stakeholders,” “Business Benefits” and “Work and Schedule.” In particular, FIG. 2 shows at 20 a set of questions that are designed to determine the degree to which stakeholders in the business are committed to a project, and FIG. 3 shows at 30 a set of questions used to determine whether business benefits are realized from a project. FIG. 4 shows a series of questions used to determine work and schedule of a project are predictable.

### Question Set

The actual set of questions in the tool has been carefully selected and vetted, to meet the requirements of removing subjectivity, providing early indication of key risk factors for project failure, and also providing backward compatibility into legacy reporting formats. The preferred procedure includes a number of specific innovations including source of the current questions, and identifying a minimum critical question set.

Based upon analyses and investigations of multiple troubled projects in 2005, a set of about 130 questions were initially identified that covered the behaviors that were linked to the projects' problems. The questions covered project management and technical domains.

This larger set was refined to a minimum core set of about 76 that constitute the “Certify” question set; these represent a minimum spanning set that contain the key probes for risky project approaches and behaviors. By applying these questions to all projects, it will ensure that all of these key factors are assessed across the portfolio.

### Question Design

In order to achieve the goals of non-subjectivity and consistency of interpretation, the design of the questions was critical. In addition, it is important that the process of supplying the information not be too onerous, so it was preferred that yes/no type questions be used wherever possible to make the surveys quick to fill out.

To test for proper behaviors (e.g., has implemented risk management), the questions do not ask if you think you are doing a good job; instead the questions try to ask for objective evidence of behaviors. These would include work products, schedule milestones, meeting frequencies, etc.

In some cases, existing subjective questions were retained or there was no objective evidence to ask for (e.g., opinion of mid-project customer satisfaction). In these cases, various methods are used to make the questions less subjective and to give a result more amenable to analysis (example: ask for a 1-10 ranking of the understanding of the customer's business case for a project, with definition of interpretation of the scale offered).

As part of the overall effort to develop the certify question set, a set of criteria is used to evaluate the value and appropriateness of including a question in the Certify set. This includes considerations like: does it identify a known problem behavior, is it worded such that an objective answer is required, is a negative result actionable, etc.

### Question Scoring

The tool implements an innovative and somewhat subtle scoring mechanism that recognizes that different questions have different contributions to the status of the project. Questions contribute points towards an individual 7 key score and an overall score. The more points accumulated, the worse the status. Red, yellow, or green status is determined by thresholding the actual scores against different fractions of the maximum possible score. For example, red status may equate to “Actual score of more than 50% of the total point score,” yellow status may equate to “Actual score is from 50% to 25% (inclusive) of the total point score,” and green status may equate to “Actual score is less than 25% of the total point score.”

Certain questions are identified as key indicators of troubled projects. A sufficiently bad answer to one of these questions turns that particular 7 Keys key “red” regardless of the other question results on that key. In essence, these questions override the normal cumulative scoring behavior.

Some questions are indicative questions and a bad answer to these questions contributes up to, for example, 3 points of negative score. These questions directly reflect bad behaviors or poor performance on a project. If a project has bad answers to enough indicative questions, the key they appear on will turn yellow or red. This is the standard cumulative scoring scheme.

Certain questions, referred to as predisposition questions, identify factors that can create a predisposition to becoming troubled. Answers that indicate this can contribute up to, for example, 3 points to the key score. An example would be a very short or very long project duration. These questions will not change the color of a key by themselves (based on the number per key), but they increase the likelihood of moving to a yellow or red status when indicative questions receive bad answers.

Regardless of the type of question, the literal question answer, or answer range, or the results of calculations based upon the question answer, are scored using a zero to three scale. An answer that indicates proper or best practice receives a zero score (no points contributed to the key total). Progressively less desirable question answers can receive scores of one, two or three. Additionally, the key indicator question will have an answer or range of answers that will trigger a sufficiently large score to ensure that the entire key will have a red status.

Preferably, both earned and unearned values are used. The Certify Tool, as an example, uses earned value calculations to take a relatively small number of financial numbers (6) (BAC, BCWS, BCWP, ACWP, GPP, GPITD) and then calculate and score classic variance and index values derived from these numbers, to assess project delivery performance against project management EV norms. Also, an index referred to as gross profit index or GPI may be used; where GPI=(actual gross profit/price case baseline gross profit). In addition, in anticipation of integrating with existing financial reporting systems that do not capture EV, to get the financial numbers used in the certify scoring calculations, an alternate concept of requesting an “unearned value” number has been developed, to allow the tool to gather a correction factor and then perform EV calculation on the reporting system values.

Further, preferably the invention “caps” key aspect scores at a predetermined maximum value (for example, # scored questions×3), so that lots of bad answers to key indicators on one key aspect do not overwhelm the other key aspect contributions to the project status. Each key aspect can only contribute at most its predetermined maximum value to the project score, which then determines the project status by the same algorithm used for the key aspect statuses.

### Tool Delivery

The question presentation, answer gathering and scoring may be implemented, for example, in a Lotus Notes tool, which has a number of features, including an invitation model, hidden scoring, support for analysis, and 7 Keys scoring.

With the invitation model, projects and submitters are administratively setup in the tool, with initialization data. An invite is sent to the submitter with options to automatically create the Notes database link and all other steps up through opening the actual survey.

With hidden scoring, the scoring effects of individual questions are not visible to the person filling out the survey; they only see the net Key and overall red, yellow or green assessments.

With the support for analysis, all fields, including profile data, answers, and scores are available in Notes views for export. This data can be pulled into desktop tools via ODBC for analysis. Currently, Visual Basic code in MS Access supports format conversion to allow trend analysis and other portfolio-wide assessments. For example, monthly reporting of data may be required to establish predictable trends based on the consistency of the process.

With 7 Keys scoring, the algorithmic scoring approach results in an overall red, yellow or green status for the project and a status for each of the 7 Keys. This representation is familiar to the traditional users of the project management reporting, so they can continue to directly use this representation from the Certify tool, and the output can be directly fed into other tools that work with this 7 Keys representation.

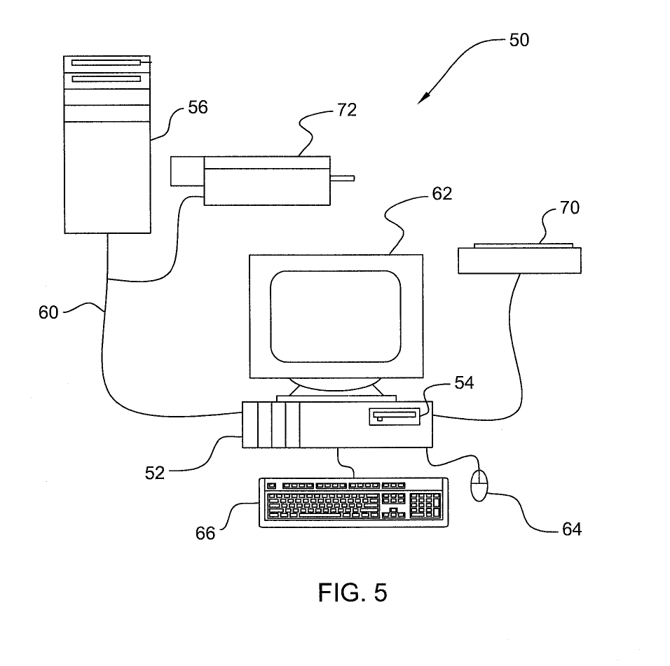

The method of the present invention may be implemented, for example, by a computer executing a sequence of program instructions for carrying out the steps of the method and may be embodied in a computer program product comprising media storing the program instructions. Referring to FIG. 5, a computer system 50 is depicted on which the method of the present invention may be carried out. Processing unit 52 houses a processor, memory and other system components that implement a general purpose processing system that may execute a computer program product comprising media, for example a floppy disc that may be read by processing unit 52 through floppy drive 54.

The program product may also be stored on hard disk drives within processing unit 52 or may be located on a remote system 56 such as a server, coupled to processing unit 52, via a network interface, such as an Ethernet interface, represented at 60. Monitor 62, mouse 64 and keyboard 66 are coupled to processing unit 52 to provide user interaction. Scanner 70 and printer 72 are provided for document input and output. Printer 72 is shown coupled to processing unit 52 via a network connection, but may be coupled directly to the processing unit. Scanner 70 is shown coupled to processing unit 52 directly, but it should be understood that peripherals might be network coupled or direct coupled without affecting the ability of workstation computer 50 to perform the method of the invention.

The present invention has additional merit in a client-server network environment. This allows different people to be involved in the workflow of completing and approving the questions set and in reviewing aggregate assessment responses (i.e., a portfolio of projects).

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The preferred embodiment of the invention provides a number of important advantages. One significant advantage is that all data is stored and made available in a consistent form for aggregate analysis (across time, geography and projects) by external processes. This allows the ability to recognize early-stage troubled projects in large portfolios (thousands of projects) and to also improve the assessment questions, by identifying questions that are confusing or of low value.

Another important aspect of the approach of the present invention is that the scores are associated with the answers, not with the questions. More conventional “linear” schemes tend to weight question contributions to an overall status to adjust sensitivity, but this has the drawback that emphasizing one question then inherently de-emphasizes other questions, no matter what answer is given (this is a limitation with existing assessment tools' similar capability). By associating the scoring value directly to specific answers (or answer ranges), the present invention can achieve a non-linear scoring behavior that recognizes that a question may be relatively unimportant until a sufficiently bad answer is given, at which point it becomes critical.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of assessing the status of a project, comprising the steps of:
identifying a multitude of key aspects of the project;
defining first, second, and third states for the key aspects;
identifying a series of questions relating to the project, including the steps of (i) identifying an initial group of questions based on analysis and investigation of multiple earlier projects, (ii) identifying a set of criteria to evaluate said initial group of questions, and (iii) refining said initial group of questions to a core group of questions by using said set of criteria;
for each of the key aspects of the project, selecting an associated set of questions from said core group of questions;
for each of the sets of questions (i) identifying at least one of the questions as a key indicator of a troubled project, (ii) identifying a first subset of the questions as indicative questions that directly reflect bad behavior or poor performance on a project, wherein predetermined answers to said indicative questions contribute given scoring values to the associated key aspect, and (iii) identifying a second subset of the questions as predisposition questions that identify factors that can create a predisposition to the associated key aspect becoming troubled;
scoring each of the key aspects based on the answers to the associated set of questions; and
assigning one of the three states to each of the key aspects based on the scores of said each key aspect, including the step of assigning any of the key aspect to the first state if predetermined answers are given to any key indicator of the set of questions associated with said any key aspect.

2. A method according to claim 1, comprising the further steps of:
scoring the project based on the scoring of the total set of key aspects; and
assigning one of the three states to the project based upon the combined score of said each key aspect, including the step of limiting the contribution of any of the key aspect to the project score, as when predetermined answers are given to any key indicator of the set of questions associated with any said any key aspect, to a maximum predetermined contribution from any said key aspect.

3. A method according to claim 1, wherein the set of criteria includes:
whether the question identifies a known problem behavior; and
whether the question is worded such that an objective answer is required.

4. A method according to claim 1, wherein:
a majority of the core questions are yes/no type questions;
some of the core questions ask for a numeric ranking; and
the questions ask for objective evidence of behavior, including work products, schedule milestones and meeting frequencies.

5. A method according to claim 1, wherein scoring of the key aspects provides a standard benchmark for status reporting that is common across the globe and therefore a consistent measure of projects.

6. A method according to claim 1, wherein the core questions are based on risk management, project management, system engineering, architecture, and testing disciplines to probe projects and to solicit objective responses with scores and a conversion of the scores into said three states to provide a consistent standard that eliminates accidental or purposeful exclusion of key details of the project.
